(19) United States
(12) Patent Application Publication
(10) Pub. No.: US 2008/0085678 A1
(43) Pub. Date: Apr. 10, 2008

(54) Mobile child monitoring system and methods of use

(76) Inventor: Ulrich Rainer Haug, Campbell, CA (US)

Correspondence Address: Szegien P. Chow, 179 Lu Ray Drive, Los Gatos, CA, 95032, US

(21) Appl. No.: 11/544,110

(22) Filed: Oct. 6, 2006

(51) Int. Cl. H04B 7/00

(52) U.S. Cl. 455/41.2

(57) ABSTRACT

A mobile monitoring system having a master or receive unit and one or more transmit or slave units is described. The system allows a person freedom of movement while being able to track through a wireless receive unit(s) persons or animals wearing or carrying a mobile transmitter. The system provides both passive or active query and response tracking of persons within a limited range. Range can be extended by incorporating additional communication features drawing from cellular networks or other wireless communication standards.

### BACKGROUND OF THE INVENTION

1. Field of the Invention

The present invention relates to a wireless location technology primarily designed for short range location of children when out of visual line of sight from their parents.

2. Description of the Prior Art

Electronic monitoring has been used to track people for various purposes. Among the more common usages are for parents to track their children, or for care givers to track the movements of patients. These systems are based on a monitoring unit having a radio receiver, and any number of tracking units which are worn or placed on the body of the persons to be tracked by the system. The monitoring unit may be a radio receiver or a desktop computer having a radio receiver attached to it. The tracking units vary from small simple transmitters to elaborate designs which may transmit health information along with location information to a fixed monitoring base station. These systems rely on energy that can be broadcast through the air, such as radio frequency (RF), ultrasonic, infrared and the like. Some systems are used to determine range and bearing from the monitoring base station to the person being tracked and utilize signal degradation to determine range. Other systems are in constant communication with the monitoring station and when the monitored signal is no longer received, an alert is produced to inform the monitoring person or care giver that the person being monitored has passed out of range. These systems are designed for the monitoring person or the care giver, to keep track of the person or people monitored. Thus the tracking units are set up for signal broadcast, but not signal receive.

Monitoring systems of the prior art have several draw backs. The use of a personal computer as a monitoring station prevents the system from being mobile. Even the use of a laptop computer as the monitoring station prevents true freedom of movement by the monitoring person or care giver. Another limitation of prior art tracking systems is a problem of tracking multiple persons simultaneously due to the inability of prior art systems to distinguish one target from another in a densely populated radio frequency environment, or environment having reflective and refractive objects of RF energy. Thus persons of interest may seem to be much farther away than they actually are, or they may appear to have moved out of range of the monitoring device. Another draw back of the prior art is the monitoring stations are restricted to a single monitoring station. These systems also do not provide for any kind of intelligent tracking of monitored persons through the tracking devices.

The mass proliferation of cellular phone technology has enabled people to stay in touch with each other when they are out of physical contact with each other, and reduced the need for tracking systems where people can communicate with each other via cell phones. The advent and commonality of cell phone technology now allows for two way voice communication with ease. Cell phones now offer direct talk, Push-to-talk-Communications (PoC), wireless web browsing and text messaging capabilities. Cell phones also provide for a level of remote sensing and location of other persons. Cell phone users can use satellite based or terrestrial based systems to locate others. Impediments to LOS can impact its usefulness. Terrestrial based systems use existing cellular network base station transceivers (BTS's) for ground based communications. The BTS transmits multiple ranging signals for a mobile station (or cell phone) in order to determine its location, BTS are added based upon the density of people residing in a certain geographical area. Consequently, more BTS exist in an area of higher population density than in an area of lower population density, which is optimized for communication purposes, and not for location purposes. A major complication in the use of cell phone technology as a tracking or monitoring tool is that requirement that both persons must interact with the equipment in order for the cell phone to be able to provide useful information (when one person calls, the other must “answer” or no location or triangulation of signal is possible). The requirement for LOS communications in a GPS system severely hampers the utility of the system when the satellite cannot communicate directly with the handset.

Thus there is a need for a monitoring and positioning system that can overcome at least some of the deficiencies of the prior art.

### SUMMARY OF THE INVENTION

Thus an object of the present invention is to provide a monitoring system that allows the monitoring person or care giver greater freedom of movement.

It is another object of the invention to allow for multiple monitoring systems if desired.

In yet another object of the invention, an intelligent system may be included to provide for the option of tracking only on demand.

These and other objectives are met by a mobile system for monitoring the position of mobile objects such as people or animals. The system has receive and transmit units that allow the holder of the receive unit to monitor the position of the transmit units. The transmit units may be a signal transmitting device, a transponder, or a full feature mobile handset (for use with a cellular phone network). The receive unit may be a dedicated device for receiving signals from the transmit devices, or it may be a device used in other applications having an added capability of receiving signals from the transmit units.

The transmit units are contained within an enclosure having a function to match their intended use. The enclosures may be disposable or reusable and are desirably tamper resistant. A wireless protocol is used to communicate between the transmit and receive units.

Methods of encoding a receive unit with the proper program information are also described, as well as a variety of uses which the system may be suitable for.

### BRIEF DESCRIPTION OF THE DRAWINGS

FIG. 1A illustrates the relationship of the components of the system.

FIG. 1B illustrates an example of multiple systems operating in a common environment.

FIG. 2A shows one possible GUI of the monitoring unit.

FIG. 2B shows a receive device attached to a commercial electrical device.

FIG. 3 Shows a Log scale GUI.

FIG. 4 shows a monitoring system combined with a cellular phone network

FIG. 5 illustrates a monitoring system with a GPS capability.

FIG. 6 illustrates a slave unit information snapshot.

### DESCRIPTION OF THE VARIOUS EMBODIMENTS

Described herein is a mobile monitoring system for tracking objects. The system has two components. The first component is a receive device, and the second component is a transmit device. The receive device is a mobile receiving unit, designed to receive signals sent by the transmit device. There may be more than one receive device or more than one transmit device in the system. The system operates in one embodiment as a closed signal system, so that multiple systems may operate simultaneously in a public environment without interfering with each other. Wireless protocols which allow these kinds of wireless networks are well understood in the art, and are not described in detail here except those elements needed to expand on the present disclosure.

The present system is designed for use by one person to track the position of one or more mobile objects, such as other persons or animals. The receive unit is the master device from which all other elements in the system will be referenced toward in the present description. The transmit units may be made into toys, decorative fashion accessories or other suitable casings for children to wear or carry. The transmit units may also be fashioned into dongles or tags for animal collars, or attachment to other kinds of animals so that the receiver unit can track the range and bearing of the transmit units in space.

In one embodiment, the transmit device or unit, has a power supply, a RF circuit and an RF transmit capability within a portable enclosure. The receive device has a power supply, a RF receive circuit, a processor, a user interface, and sufficient processor operation capability to process information received from the transmit unit, and convert it into range and bearing data that can be displayed or otherwise presented in a human recognizable format through the user interface. A timing element may be incorporated into the RF circuit to produce transmit signals at regular or predetermined intervals.

In another embodiment, the receive unit has the ability to program another receive device to be a clone of itself. In this manner if the transmit unit wanders out of range of the receive unit, the receive user may program additional devices to act as receive units so that multiple persons may seek out the wandering transmit unit.

Communication between the transmit and receive unit is desirably through a wireless protocol, such as Bluetooth™ or other system of data transfer. The transmit unit may either continuously broadcast a signal, or broadcast signals at any desired time intervals. If the transmit unit has some sort of receive capacity, the transmit unit may also broadcast a signal in response to a query from the receive device, or other authorized receive device. In one embodiment, the transmit unit operates as a simple beacon in the system. Range and bearing information are obtained by the receive device based on the strength and bearing of the signal received from the transmit device, and/or information contained within the transmit signal as described herein.

The receive device may be a dedicated receive unit designed for operation with the system described herein. Alternatively, the receive device may be a cell phone, PDA or other wireless communication device. The receive unit has a RF receive circuit, capable of receiving RF signals from the transmit device. The RF receive circuit may incorporate an omni-directional antenna and a direction discriminating antenna. The receive unit also has a processor for identifying the correct RF signal for the system and determining the range and bearing of the transmit unit. Once the processor has determined the range and bearing information, it is displayed or otherwise provided in a manner that is readily understood by a user carrying the receive device.

The transmit unit is contained in an enclosure which may be “disguised” in a shape or object which can be readily attached to children's clothing, or part of a child's toy, or made into a tag for an animal (like hunting dogs). Other applications may include using the system for tracking people in public places, animals in parks or other wide open spaces.

In referring to the accompanying drawings, it should be understood the drawings provide representative information for assisting in understanding the present disclosure. The drawings are not to be considered in any limiting sense as the invention scope is represented in the accompanying claims. Items shown in the drawings are not to scale with reference to other drawings nor are they to scale within any particular drawing. Parts identified in the drawings with numbers may have subscripts or letter variables accompanying them. Subscripts indicate variables used in a similar manner to general scientific or mathematical annotation. E.G. part 200ₐ₋ₙ refers to multiple part numbers 200, starting at part “a” and ending at part “n”. Parts identified in the manner may not be called out specifically herein except to be referred to in plural of part 200.

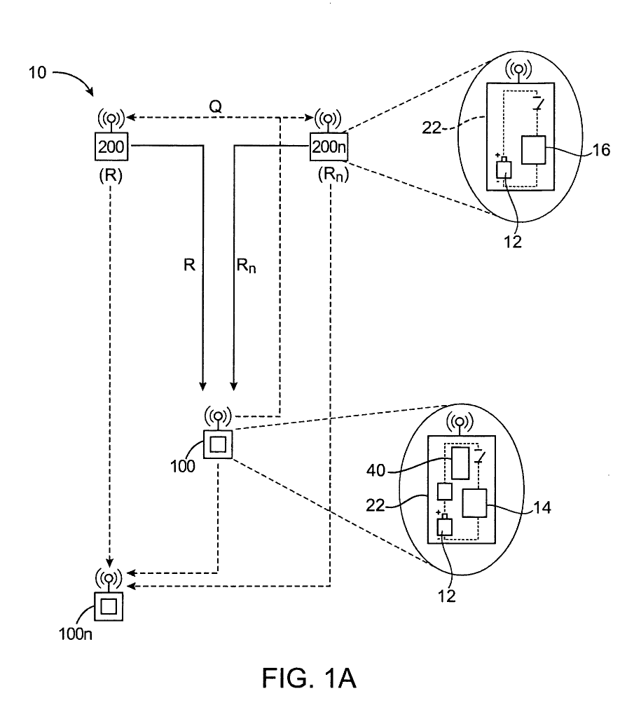

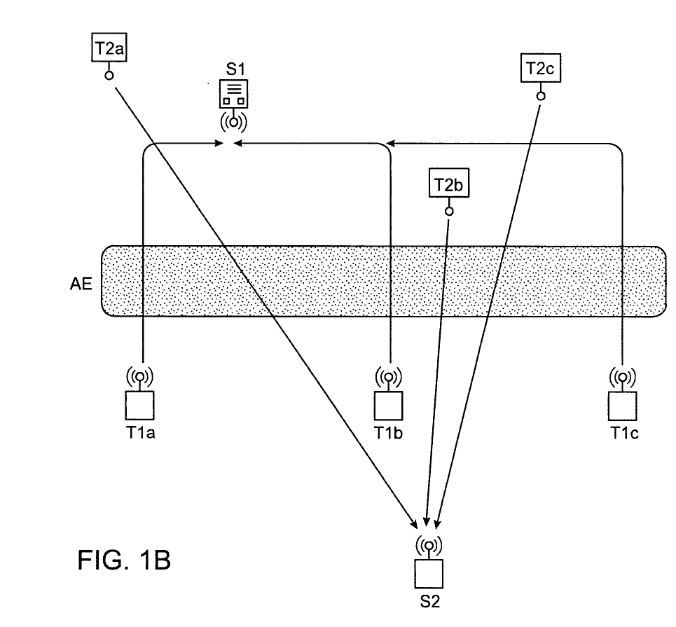

Now turning to the drawings, FIG. 1A illustrates the relationship between the basic components of the system 10 described herein. A receive unit 100 is shown having the capacity to receive signals from one or more transmit units 200 within a limited range of the receive unit 100. Both the transmit 200 and receive 100 units are contained individually within portable enclosures 22. Each has a power source 12. The receive unit has a RF receive circuit 14 while the transmit has an RF transmit circuit 16. Both transmit 200 and receive 100 units have an antenna, and desirably have a power switch. Desirably the receive unit 100 also has a graphical user interface (GUI) 40 for identifying the range and bearing to the transmit device(s). The transmit units 200 are desirably capable of transmitting an RF signal in broadcast mode (all directions). Desirably this broadcast is done through a low power, customizable communication protocol. However power consumption may be regulated by using a signal query Q and signal receive R function instead of a continuous or interval broadcast method. The signal transmitted by the transmit unit 200 is received by the receive unit 100. The distance between the transmit and receive may be determined by extrapolating the signal strength of the signal, while the direction may be determined by using a directional antenna or other signal direction discriminating element in the receive unit. In an alternative embodiment, the transmit units may also have a receive antenna so as to receive a query signal Q from the receive unit or the master unit. The transmit or slave units will then transmit a short signal in broadcast mode so the master unit can attempt to lock into the signal of the slave unit. The slave units may easily be designed to have a single query and response mode (one query, one response) or to produce a continuous response to a single query until the master unit sends a “stop” command that will stop broadcasting from the slave unit. The slave unit may also be designed with an automated power detection circuit that will alert the master unit when the slave unit is low on power. Desirably the individual units of the system will have user accessible power supplies for easy replacement. Additional receive units 100n may be cloned from the first receive unit, or built into the system to accommodate multiple persons able to track the transmit units.

FIG. 1B shows an environment having multiple systems of the present invention operating simultaneously and independently of each other. Each system may operate on a unique communication frequency, hand shake protocol or communication protocol that allows it to operate in an ambient environment AE which is likely densely populated with a large variety of other RF sources. Various protocols are available to provide for distinguishing one system from other. For example the system could utilize a built in data encryption key for all signal information. An oscillating protocol such as Bluetooth may be used, or a selective frequency of signal calibration can be used. The particular manner of transmit/receive and identity is not particularly important so long as the systems may operate within the ambient environment AE of modern society without substantial degradation of operational abilities. Here a first system S1 is operating across an ambient environment AE to communicate with one or more transmit stations T1ₐ₋ₙ, while simultaneously another system S2 is communicating with one or more transmit stations T2ₐ₋ₙ across the same ambient environment AE. The ambient environment AE is comprised of random signals from other radio emitting and receiving devices. The AE also comprises non-self systems of the present invention which are not part of the system components trying to communicate among themselves.

If the receive unit and transmit unit possess the capabilities for two way communication between them, then the receive unit is referred to herein as the master unit, and the transmit is referred to as the slave unit. Both the master and slave units may be designed with a large set of features. Alternatively complex devices already commercially available may be used to operate as master and slave units within the scope of the present disclosure. In one non-limiting example, a cellular telephone may be used as the master device. Cell phones possess discriminating antennas and operate on RF signals. A software program can be loaded into the cell phone (in the form of a downloadable executable file) that would allow the cell phone to act as a master unit. Slave units may be other cell phones, or desirably made as part of a system to be operated in combination with a master unit. The slave unit is desirably in the form factor of something that will appeal to a child or disguised so as to be unnoticed while worn or carried by a child or other person being tracked. Thus a parent can keep track of a child without others or the child being aware of the monitoring if so desired.

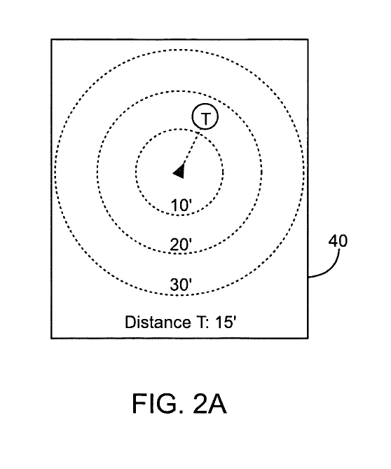

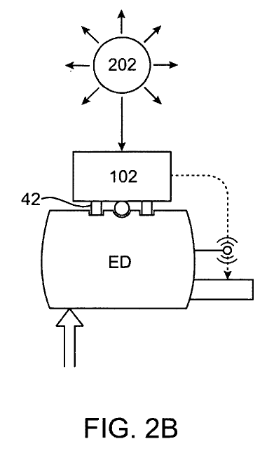

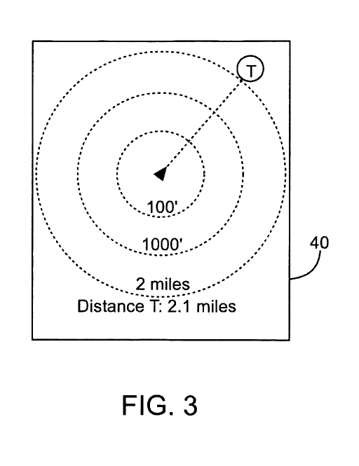

The master unit may incorporate a GUI 40 similar to that shown in FIG. 2A. A series of range circles arranged in either linear or logarithmic (FIG. 3) progression may be used to measure distance between the master unit and the slave units. Though the master unit is illustrated here as being in the center of concentric range circles, the GUI may display the relative positions in any manner desired. It is not necessary that the master unit be illustrated at all, nor that the GUI be visual. A user interface may be audible instead of visual, or a combination of the two. Desirably the master unit incorporates an omni-directional antenna having a directional discriminating ability. The master unit may further possess a primary antenna for better reception when the primary antenna is oriented directly toward the transmit signal. The user may be guided by the GUI when the omni-directional antenna picks up the transmit signal, and direct or indicate to the user how to orient the device so the primary antenna can get better reception. The antenna description here is merely an example and in no way limiting of the invention scope as the antenna and reception of signal, per se, are not considered inventive to the present disclosure. Desirably the GUI may also display compass directions. The receive unit may also have a memory capable of storing, among other things, the last known position of the transmit device, and reproducing the image of that location on the GUI whenever desired.

In yet another embodiment is shown in FIG. 2B. The slave unit 202 is shown broad casting in all directions. The signal is received by the receive circuit 102 which is attached to another electronic device. The attachment may be through a piggy back (e.g. a daughter card), or insertion into an available slot like SD, MMC or other memory device. The receiver determines the range and direction from the slave unit and send that information through an electronic interface 42 (e.g. UART, SPI, SD, MMC, IIC and the like) or by transmitting the information from the receive unit to the antenna of the electronic device ED. The signal received may be interpreted by the receive circuit or the electronic device ED, so long as one of them has some intelligence for live information feed. The information may be displayed on the GUI of the electronic device. If the electronic device is a cell phone, PDA or other commercially available device, then the software for interacting with the receiver may be downloaded, and updated with relative ease.

FIG. 3 illustrates one possible GUI using a logarithmic scale to show the range and bearing using an outside signal system such as those described herein. The receive/master unit may query for the transmit/slave unit directly, and then failing to detect the transmit/slave unit, the master unit may switch to a popular network system (Cellular phone network, WLAN system, etc.) and query for the transmit device. When the transmit responds, the user of the receive/master sees the location of the transmit on the GUI.

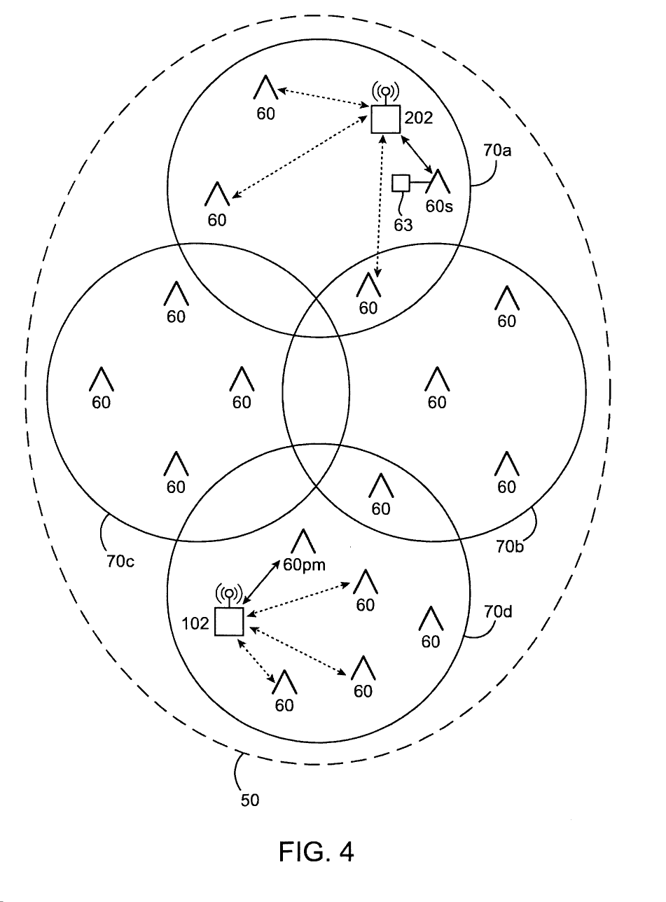

Alternatively, the transmit and receive unit may take advantage of expanded capability and use the operations of a cellular network to identify the location of the transmit units 202, as shown in FIG. 4. In this embodiment, the transmit device 202 includes a transmit circuit having sufficient capability to communicate with the cellular network 50. The transmit unit desirably has the necessary send and receive capabilities to operate like a cell phone within the network 50, comprising numerous cells 70ₐ₋ₙ. The receive unit 102 resides within one “cell” 70_{d} and communicates with the closest or primary tower 60ₚₘ. The transmit unit may use the same tower, or any other tower in the network. The closest tower or the tower that communicates with the transmit unit becomes the transmit unit's link tower 60ₛ. If the link tower 60ₛ has a location monitoring unit 63, then the tower can locate the transmit unit by using a triangulation location program. Otherwise the transmit unit can provide its own location information as described below. Because the transmit device does not need to have any GUI for the user to take advantage of, the transmit device may still be small and fashioned in a manner as to be generally unnoticeable to the casual observer. In still another embodiment, the transmit device may be equipped with the necessary components to work with the E911 protocol. Once again because the transmit device is designed primarily for use with those persons who will not interact with the device (young children, persons with disabilities, advanced seniors or animals), the transmit device may incorporate the features described herein while still maintaining a relatively small foot print.

While the transmit device may be visible to the cellular network at all times, desirably the visibility of the transmit device on a cellular network will only come about after the receive unit engages an additional feature that “publishes” the transmit unit. Thus a parent or care giver can monitor a person within the range of the system and if the monitored person wanders or is taken outside the monitoring range of the monitoring unit, the user can activate an added parameter that will publish the monitored person to the network. Once the publication is done, the user may use the capability of the cellular network to track down the position of the desired monitored person. The transmit unit must be so enabled as to correspond to the beacon parameters of these aforementioned communication protocols. The incorporation of these additional features is primarily a function of power available to the transmit unit. Thus the transmit unit may be available in a basic design, or a more sophisticated design having the required circuitry and power to enable these added features.

Alternatively, the publication of the location of the transmit device on a cellular network may act as an alert to the system operators of the network that the person being tracked is missing. The network operators may communicate with the master device, or local authorities, to provide the proper and timely recovery of the transmit device holder.

Any of the expanded features of the basic system described herein are desirably based on user controlled switches. The user may turn any of the features on or off in any combination at will.

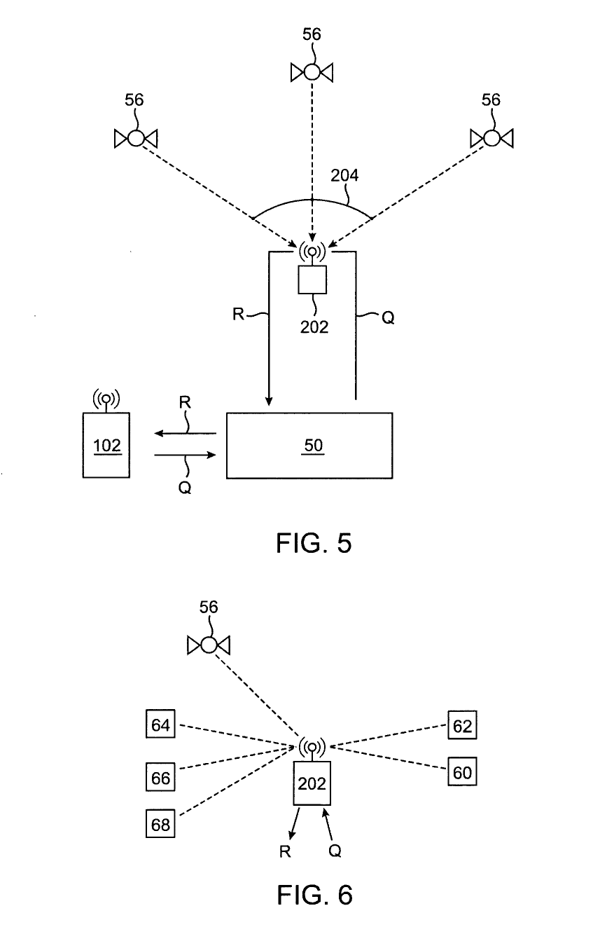

In another embodiment, the feature set of the transmit device is expanded even further to include receiving signals 204 from GPS satellites 56, or other satellite based location systems (FIG. 5). In this embodiment the slave unit 202 is able to receive signals from GPS satellites and use that information to determine its location. That information is then forwarded on to the master unit either directly (through the RF communication protocol between the master and slave unit) or through a wireless network 50, such as a cellular phone network.

The slave unit may possess all the feature capabilities of a modern cell phone. In one embodiment the slave unit possesses the circuitry for interacting with a cellular network. Such features may include, but are not limited to, receive and transmit functions that allow the unit to register properly with the network, monitoring neighboring cells, ability to obey other network rules, and respond to ‘query’ and transmit location information (e.g. derived location from SMS, GPS or other methods). In one embodiment, the slave unit 202 is turned on, and then registers on a cellular network 50. It broadcasts its self identifying information locally to be received by the master 102. The slave unit is registered on the cell network 50 at the same time so it can “listen” for an incoming call. If the master unit querys the slave through a wireless network 50 (such as a cellular network), the master makes a call or query Q to the slave unit 202. The query Q is relayed to the slave from a local cell tower. The query Q activates a response R in the slave. In this embodiment, the master 102 communicates with the primary local tower 60 while the other towers 60 continually listen for a change in position of the master 102. The query Q travels through the wireless network 50, which is this example is a cell phone network. The slave unit 202 is registered with a separate tower. When the slave receives the query signal from the local tower, it then executes the desired response protocol (data collection and transmit, transmit to cell network, etcetera) and the information is relayed through the wireless network to the master unit 102.

The response R to query Q may vary depending on design. In one alternative embodiment, the slave responds immediately with a response signal that may be used by the cellular network to triangulate the position of the slave, using a location monitoring unit or similar technology, and then send the position data to the master unit. The master unit displays the appropriate information allowing the user to move toward the slave. Once the master is in range of the primary wireless transmit mode of the slave unit, the local short range location tracking resumes. Alternatively the transmit may receive signals 204 from GPS satellites 56 to determine its position. The position can be sent to the master and the master unit can see instead of a relative position of the slave unit (slave unit's relative position to the master unit) the master unit can show the absolute position of the slave unit (display the position of the slave unit on the GUI of the master unit).

Alternatively, the master unit 102 may send a query message through the wireless network 50 to the slave unit 202. Upon receipt, the slave unit 202 collects data or processes the data to determine its position and then send the position data (or raw data) back through the wireless network 50 so it is received by the master unit 102. The master unit either processes the raw data or displays the position information received through the graphical user interface (GUI) 40.

In another embodiment, once the slave receives a query, it may take a snap shot of all wireless activity it can perceive (see FIG. 6). In this embodiment, the slave unit 202 now picks up all the signals in its capability and desirably has antenna and receive circuits to capture other RF/wireless information besides that required to properly communicate with the cellular network. The snapshot of information captured may include GPS 56 signals, cell tower 60 information, other cell phones 64, WLAN sources 62, other RF transmitters 68 or any other wireless 66, (such as infrared or ultrasound) information the slave unit is capable of listening for. The snap shot of data is then transmitted to the cell tower as the response to the query from the master unit. The master unit receives the bundle of data and processes the information to determine the slave unit location. Again the user can move toward the slave unit until the primary short range location system is able to track the slave unit again.

In still another embodiment, the slave unit itself may process the data, either partially or fully, from the snap shot and then transmit the position information to the master.

While the above description details operation of the master and slave within a cellular network, desirably the expanded capability will be through any wireless public data system available. The slave unit may possesses all the features described herein while maintaining a minimal foot print. The circuitry and power supply along with antenna(s) are fairly small and can be fashioned into a small enclosure. There is no need for any sort of user interface (no display or keypad) thought the unit may have a physical on/off switch.

In still another embodiment, a panic mode or query operation may be incorporated into the system in any of the designs and embodiments described herein. The query mode requires the transmit unit to have a receive element as well as a transmit element. The receive element need not be an intelligent circuit combined with the transmit unit. Instead the receive unit may deliver a simple trigger to pulse power through the transmit circuit so that as soon as a query command is received, the transmit unit automatically sends out a transmit signal. If the transmit unit is designed to continuously broadcast information or if it is designed to transmit at regular intervals, then the query may force a boosted signal to be sent to the receive device. The signal or boosted signal can be read as normal by the receive unit provided the two units are within communications range of each other. The boosted signal desirably possesses additional information allowing the receive unit to properly identify the received signal as coming from transmit unit in panic mode.

An interactive panic mode may also provide an alert to the person wearing or carrying the transmit/slave unit. When the transmit/slave unit receives the panic signal, it causes the wearer or carrier of the transmit unit to become aware that the receive unit is actively seeking the transmit unit. This may take the form of an alert sound or an instruction to the wearer to seek out and return to the receive unit holder (e.g. cause a child to return to their parent if able).

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A mobile monitoring system for tracking persons, the system comprising:
one or more transmit unit(s) having a power supply, a RF circuit and an RF transmit capability within a portable enclosure;
a mobile receive unit having a power supply, a RF receive circuit, and a user interface;
wherein said transmit units broadcast RF signals to said mobile receive unit so that the position of each transmit unit(s) may be identified relative to said mobile receive unit.

2. The system of claim 1, wherein the RF protocol is Bluetooth® and said system is adapted for Bluetooth® communication protocols.

3. The system of claim 1, wherein the mobile receive unit is a cell phone, wireless PDA or other portable consumer electronic device.

4. The system of claim 1, wherein said mobile receive unit further comprises a transmit circuit for “querying” said transmit unit(s).

5. The system of claim 1 further comprising two or more mobile receive units wherein each mobile receive unit is a RF clone so as to be able to receive and process signals from said transmit unit(s).

6. The system of claim 1, wherein said receive device further comprises a RF omni-directional antenna.

7. The system of claim 1, wherein said transmit unit is a transponder.

8. The system of claim 1, wherein said transmit unit is incorporated into a consumer product.

9. The system of claim 1, wherein said mobile receive unit may query said transmit unit(s) through a cellular phone network.

10. The system of claim 1, wherein said mobile receive unit may receive GPS and/or other location information for said transmit unit(s) through a cellular or other communications network.

11. The system of claim 1, wherein said transmit unit may receive querys through a cellular phone network, or other wireless data network, and respond to said querys through the same transmission protocols.

12. A mobile monitoring system for tracking persons in an open volume, the system comprising:
one or more transmit unit(s) having a power supply, a RF circuit and an RF transmit capability within a portable enclosure;
a mobile receive unit for use with a cell phone having a RF receive circuit and an electronic interface for communicating with said cell phone;
wherein RF information from each transmit unit is received by the mobile receive unit, and sent to the cell phone for data processing and GUI interpretation.

13. A method of modifying a wireless consumer electronic communication device to receive and process RF transmit information from one or more mobile transmit units, the method comprising the steps of:
loading a software program into a persistent memory device in said wireless consumer electronic communication device;
accessing said software program from said persistent memory device;
receiving RF signals from said transmit unit(s); and
processing said signals to produce range and bearing information to a user of said wireless consumer electronic device.

14. The method of claim 13, wherein the RF receiver may be cloned via an internet transfer protocol.
